(19) United States
(12) Patent Application Publication
(10) Pub. No.: US 2008/0155884 A1
(43) Pub. Date: Jul. 3, 2008

(54) Fishing Lure Apparatus and Method

(76) Inventor: Norman Lee Sisson, Winter Haven, FL (US)

Correspondence Address: Walter J. Tencza Jr., Suite 210, 100 Menlo Park, Edison, NJ, 08837, US

(21) Appl. No.: 11/619,459

(22) Filed: Jan. 3, 2007

(51) Int. Cl. A01K 85/00

(52) U.S. Cl. 43/42.47; 43/42.49; 43/42.4

(57) ABSTRACT

A fishing lure and a guard are provided. The fishing lure may have a lip, a body portion, and at least one hook. The lip may include a front end, and a rear end, the rear end connected to the body portion of the lure, the front end opposite the rear end. The apparatus may also include a means for attaching a fishing line directly to the lip, and a means for attaching the guard near the front end of the lip. The guard may have a first end, which is attached near the front end of the lip, and a second end, which is attached to the fishing line through the second end of the guard. A first loop may be located at the first end of the guard, and a second loop may be located at the second end of the guard.

### FIELD OF THE INVENTION

This invention relates to improved methods and apparatus concerning devices for fishing.

### BACKGROUND OF THE INVENTION

There are various fishing lures and fishing related devices known in the prior art.

### SUMMARY OF THE INVENTION

In one embodiment of the present invention an apparatus is provided comprising a fishing lure and a guard. The fishing lure may have a lip, a body portion, and at least one hook. The lip may include a front end, and a rear end, the rear end connected to the body portion of the lure, the front end opposite the rear end. The apparatus may also include a means for attaching a fishing line directly to the lip, and a means for attaching the guard near the front end of the lip. The guard may have a first end, which is attached near the front end of the lip, and a second end, which is attached to through the second end of the guard.

A first loop may be located at the first end of the guard, and a second loop may be located at the second end of the guard. The guard may be made of metal wire. The lip may be flat and rigid.

In one embodiment of the present invention, a method is provided including attaching a first end of a guard to a front end of a lip of a fishing lure, attaching a first end of a fishing line directly to a lip of the fishing lure, and inserting the fishing line through a second end of the guard, the second end of the guard opposite the first end of the guard.

### BRIEF DESCRIPTION OF THE DRAWINGS

FIG. 1 shows a right side view of an apparatus in accordance with an embodiment of the present invention, with the apparatus shown in a first state;

FIG. 2 shows a right side view of the apparatus of FIG. 1, with the apparatus shown in a second state;

FIG. 3 shows a top view of the apparatus of FIG. 1;

FIG. 4 shows a bottom view of the apparatus of FIG. 1; and

FIG. 5 shows a front view of the apparatus of FIG. 1.

### DETAILED DESCRIPTION OF THE DRAWINGS

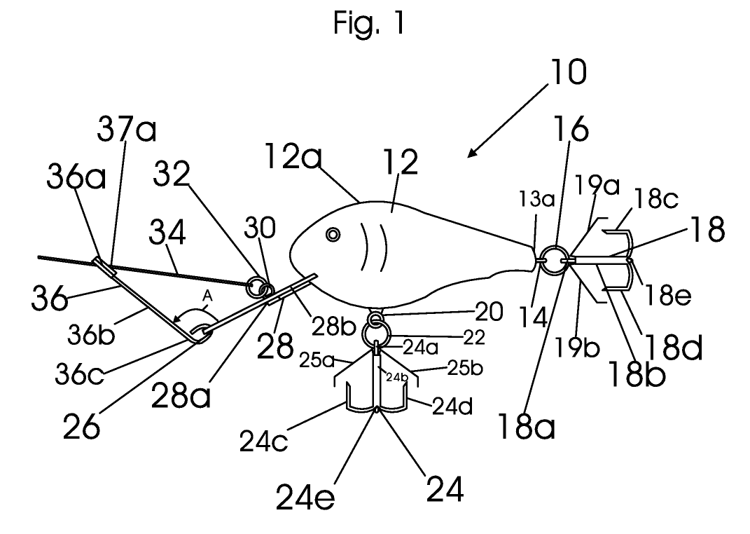

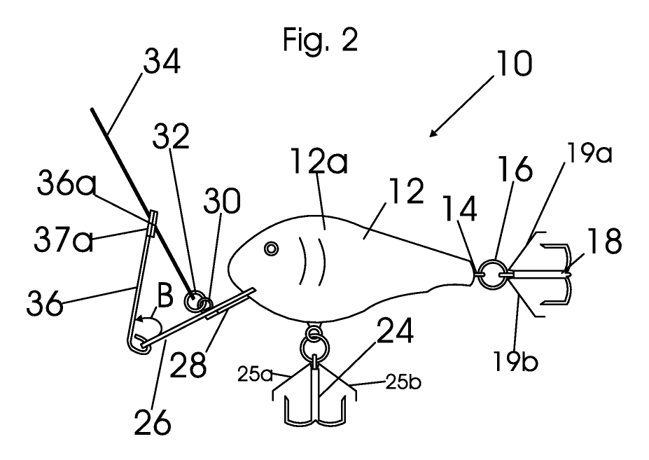

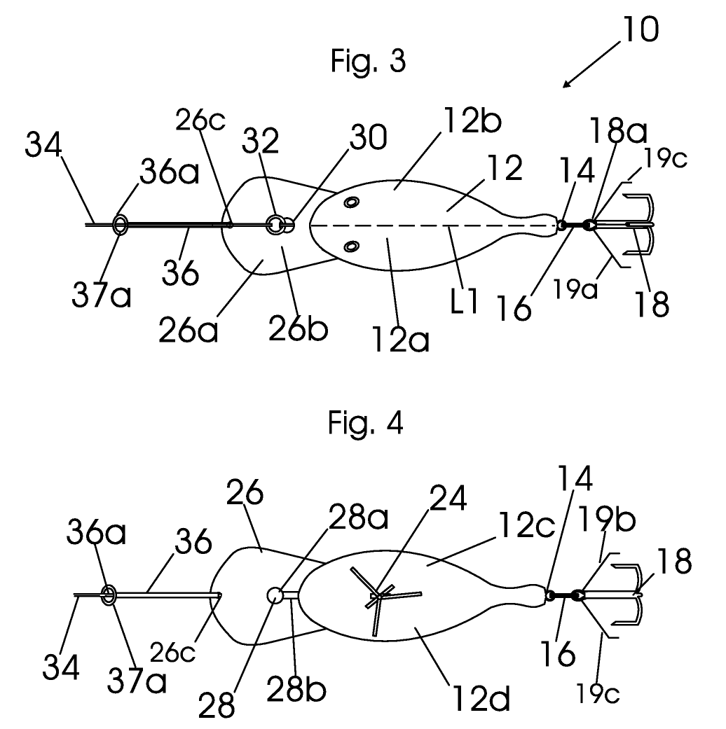

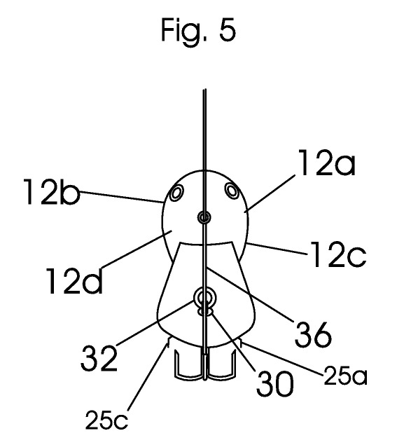

FIG. 1 shows a right side view of an apparatus 10 in accordance with an embodiment of the present invention, with the apparatus 10 shown in a first state. FIG. 2 shows a right side view of the apparatus 10, with the apparatus 10 shown in a second state. FIG. 3 shows a top view of the apparatus 10. FIG. 4 shows a bottom view of the apparatus 10. FIG. 5 shows a front view of the apparatus 10 of FIG. 1.

Referring to FIGS. 1-5, the apparatus 10 includes a body portion 12, a ring or loop 14, a ring or loop 16, a hook device 18, a ring or loop 20, a ring or loop 22, a hook device 24, a lip 26, a reinforcing member 28, a ring or loop 30, a ring or loop 32, fishing line 34, and a guard 36.

The body portion 12 may be substantially in the shape of a fish or fishing lure, which may be made from wood or plastic. The body portion 12 may include a right top portion 12a, a left top portion 12b, a right bottom portion 12c, and a left bottom portion 12d. The ring or loop 14 may be fixed to a rear end 13a, shown in FIG. 1, of the body portion 12. The ring or loop 16 may pass through the ring or loop 14 so that the two rings or loops are connected together. The hook device 18 may include a ring or loop 18a, a member 18b, and hooks 18c, 18d, and 18e.

The ring or loop 20 may include a portion 20a fixed at the boundary of the left bottom portion 12d and the right bottom portion 12c. The ring or loop 20 may include a portion 20b through which a ring or loop 22 passes. The hook device 24 may include a ring or loop portion 24a, which passes through the ring, or loop 22 and which is connected thereby. The hook device 24 may also include a member 24b, and hooks 24c, 24d, and 24e.

The lip 26 may be a plastic or metal rigid plate. The reinforcing member 28 may be made of a rigid waterproof material such as metal or plastic and may help to keep the lip 26 rigid. The ring or loop 30 may be mounted to the member 28 and thereby to the lip 26. The ring or loop 32 passes through the ring or loop 30, and is thereby connected to the ring or loop 30. The fishing line 34 may be connected, such as fixed by tying, to the ring or loop 32.

The guard 36 includes a loop or ring portion 36a, a member 36b, and a loop portion 36c. The loop portion 36c connects the guard 36 to the lip 26 through a hole 26c shown in FIGS. 3 and 4. The ring portion 36a has an opening 37a. The fishing line 34 passes through the opening 37a in the ring portion 36a.

The apparatus 10 may include hook guards 25a, 25b, and 25c shown by FIGS. 1, 2, and 5 which guard hook device 24, and hook guards 19a, 19b, and 19c shown by FIGS. 1-4, which guard hook device 18. More specifically, hook guards 25a-25c guard hooks 24c-e, respectively, and hook guards 19a-c guard hooks 18c-e, respectively. The hook guards 25a-25c and 19a-c prevent or inhibit debris, such as seaweed from accumulating on their respective hook of hooks 24c-e and 18c-e. Each of the hook guards 25a-c and 19a-c may be a thin metal wire.

In operation, the lip 26 may accumulate some debris, such as seaweed. The guard 36 by changing positions, such as, for example from the position of FIG. 1 to the position of FIG. 2, may operate the push debris off of the lip 26. The guard 36 may change positions from an angle A shown in FIG. 1 to an angle B shown in FIG. 2, with respect to the lip 26.

The guard 36 may be made of metal wire, plastic, or some other material. The guard 36 attaches to the front of the lip 26 providing a barrier to prevent objects from hanging on the lip 26. The guard 36 does not change the action of the apparatus or lure 10.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a guard; and
a fishing lure, the fishing lure having a lip, a body portion, and a first hook, the lip comprising:
a front end, and a rear end, the rear end connected to the body portion of the lure, the front end opposite the rear end;
a means for attaching a fishing line directly to the lip;
and a means for attaching the guard near the front end of the lip;
wherein the guard has a first end and a second end;
wherein the first end of the guard is attached near the front end of the lip; and
and the fishing line is inserted through the second end of the guard.

2. The apparatus of claim 1 wherein
a first loop is located at the first end of the guard;

3. The apparatus of claim 1 wherein
a first loop is located at the second end of the guard;

4. The apparatus of claim 2 wherein
a second loop is located at the second end of the guard;

5. The apparatus of claim 1 wherein
the guard is made of metal wire.

6. The apparatus of claim 1 wherein
the guard is made of plastic.

7. The apparatus of claim 5 wherein
the guard is comprised of a first loop at the first end of the guard connected to a member connected to a second loop at the second end of the guard.

8. The apparatus of claim 1 wherein
the lip is flat and rigid.

9. The apparatus of claim 1 further comprising
a first hook guard fixed at a location so that the first hook guard overlaps the first hook, and the first hook guard inhibits debris from accumulating on the first hook.

10. A method comprising
attaching a first end of a guard to a front end of a lip of a fishing lure;
wherein the fishing lure further comprises a body portion, and a first hook;
wherein the lip further comprises
a rear end, the rear end connected to the body portion of the lure, the front end opposite the rear end;
further comprising
attaching a first end of a fishing line directly to the lip;
and inserting the fishing line through a second end of the guard, the second end of the guard opposite the first end of the guard.

11. The method of claim 10
wherein a first loop is located at the first end of the guard;

12. The method of claim 10 wherein
wherein a first loop is located at the second end of the guard;

13. The method of claim 10 wherein
a second loop is located at the second end of the guard;

14. The method of claim 10 wherein
the guard is made of metal wire.

15. The method of claim 14 wherein
the guard is comprised of a first loop at the first end of the guard connected to a member connected to a second loop at the second end of the guard.

16. The method of claim 10 wherein
the lip is flat and rigid.

17. The method of claim 10 further comprising
fixing a first hook guard at a location so that the first hook guard overlaps the first hook, and the first hook guard inhibits debris from accumulating on the first hook.
